(19) United States
(12) Patent Application Publication
(10) Pub. No.: US 2003/0123099 A1
(43) Pub. Date: Jul. 3, 2003

(54) Internet facsimile machine

(75) Inventor: Yoshifumi Tanimoto, Hirakata-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/330,992

(22) Filed: Dec. 27, 2002

(30) Foreign Application Priority Data
Dec. 28, 2001 (JP) 2001-401007

(51) Int. Cl. H04N 1/00

(52) U.S. Cl. 358/402

(57) ABSTRACT

An Internet facsimile machine includes a receiver receiving simplified image data and information of an effective period for saving original image data by an electronic mail message and a storage unit storing the received simplified image data. The Internet facsimile machine further includes a control unit controlling to transmit an image data request for requesting high quality image data with an image quality higher than that of the received simplified image data without saving the received simplified image data in the storage unit when the received effective period is longer than a prescribed threshold.

### FIELD OF THE INVENTION

The present invention relates to a full-mode Internet facsimile machine that transmits image data using electronic mail.

### DESCRIPTION OF THE RELATED ART

FIG. 2 is a sequence diagram showing a communication procedure between a full-mode Internet facsimile machine 20A and a full-mode Internet facsimile machine 20B of the related art.

In the full-mode Internet facsimile machine that transmits image data by using electronic mail via the Internet, as shown in FIG. 2, transmitting Internet facsimile machine 20A scans a document image under its maximum ability condition, or under an ability condition designated by a user. Then, transmitting Internet facsimile machine 20A stores the scanned document image in an image memory as an original image data, and forms simplified image data with a resolution lower than that of the original image data. Next, transmitting Internet facsimile machine 20A transmits a first electronic mail message including the simplified image data along with format information of the original image data and an “information of an effective period for holding the original image data”, to receiving Internet facsimile machine 20B via the Internet. In response to the first electronic mail message from receiving Internet facsimile machine 20A, the receiving Internet facsimile machine 20B returns an electronic mail message including ability information (information such as a file format of the image data, a processable resolution and its horizontal to vertical ratio, an image encoding method, and information of the width of the printing paper size) of the Internet facsimile machine 20B and an image data request to the transmitting Internet facsimile machine 20A via the Internet.

Then, the transmitting Internet facsimile machine 20A forms image data corresponding to the ability information from the original image data stored in the image memory, in accordance with the received ability information of the receiver. In addition, the transmitting Internet facsimile machine 20A transmits an electronic mail message including the image data to the receiving Internet facsimile machine 20B via the Internet. In response to the electronic mail message from the Internet facsimile machine 20A, when receiving the electronic mail message normally, the Internet facsimile machine 20B returns an electronic mail message including a delivery confirmation of “OK” to the transmitting Internet facsimile machine 20A. Moreover, when receiving the electronic mail message abnormally, the Internet facsimile machine 20B returns an electronic mail message including a delivery confirmation of “NG” to the transmitting Internet facsimile machine 20A.

In the above-described full-mode Internet facsimile communication procedure, the receiving Internet facsimile machine 20B receives the simplified image data by the first electronic mail message. Then, when an image data (including the original image data) with the image quality higher than that of the simplified image data is necessary, a second electronic mail message including the image data is requested by transmitting the image data request and the ability information of the Internet facsimile machine 20B to the transmitting Internet facsimile machine 20A. In this case, there are cases when the original image data has been erased at the transmitting Internet facsimile machine 20A before requesting the second electronic mail message including the image data. Therefore, it is necessary to execute an appropriate processing at the receiving Internet facsimile machine 20B in accordance with the “information of the effective period for holding the original image data” from the transmitting Internet facsimile machine 20A. However, conventionally, the processing based on the above information was not executed.

### SUMMARY OF THE INVENTION

An advantage of the present invention is to solve the above-mentioned problems, and to provide an Internet facsimile machine that can execute an appropriate processing at a receiver in accordance with “information of an effective period for holding the original image data” from a transmitter.

The Internet facsimile machine of the present invention is an Internet facsimile machine of a receiver for a communication system including a transmitting Internet facsimile machine and a receiving Internet facsimile machine, wherein image data is transmitted and received by using electronic mail message. Further, the transmitting Internet facsimile machine stores original image data in a first storage unit, and transmits simplified image data including information of the original image data, and information indicating an effective period for saving the original image data. The receiving Internet facsimile machine includes a second storage unit for saving the transmitted simplified image data, and receives the transmitted simplified image data and the information indicating the effective period. The Internet facsimile machine of the present invention includes a control unit for controlling to transmit an image data request for requesting image data with an image quality higher than that of the simplified image data to the transmitting Internet facsimile machine without saving the received simplified image data in the second storage unit when the received effective period is longer than a prescribed threshold.

Therefore, for example, in the case of a “permanent effective period” wherein the effective period of the original image data is longer than a prescribed threshold, the receiver does not save the simplified image data of which the original image data is saved reliably at the transmitter. In other words, a memory resource can be used effectively without saving unnecessary image data. Accordingly, the receiver can execute an appropriate processing according to the information of the effective period of the original image data from the transmitter.

Moreover, the Internet facsimile machine of the present invention is a receiving Internet facsimile machine for a communication system including a transmitting Internet facsimile machine and a receiving Internet facsimile machine, wherein the image data is transmitted and received by using electronic mail. Further, the transmitting Internet facsimile machine stores the original image data in a storage unit, and transmits a simplified image data including information of the original image data, and information indicating the effective period for saving the original image data. The receiving Internet facsimile machine receives the transmitted simplified image data and the information indicating the effective period. The Internet facsimile machine of the present invention includes a control unit for controlling to prohibit the transmission of the image data request for requesting the image data with the image quality higher than that of the simplified image data to the transmitting Internet facsimile machine when the received effective period is shorter than a prescribed threshold, by handling the received simplified image data as the final image data. Therefore, for example, in the case of the “transient effective period” wherein the effective period of the original image data is shorter than a prescribed threshold, there is a possibility for the original image data being erased after being saved only temporarily at the transmitter. Thus, the received simplified image data is handled as the final image data, and the image data request is not transmitted. Accordingly, a communication error due to the transmission of the image data request by the original image data being erased can be prevented from occurring. As a result, the receiver can execute an appropriate processing according to the information of the effective period of the original image data from the transmitter.

Furthermore, the Internet facsimile machine of the present invention is a receiving Internet facsimile machine for a communication system including a transmitting Internet facsimile machine and a receiving Internet facsimile machine, wherein an image data is transmitted and received by using electronic mail. Further, the transmitting Internet facsimile machine stores the original image data in the storage unit, and transmits the simplified image data including information of the original image data, and the information indicating the effective period for saving the original image data. The receiving Internet facsimile machine receives the transmitted simplified image data and the information indicating the effective period. The Internet facsimile machine of the present invention includes a control unit for controlling to execute a prescribed processing to the received simplified image data when the received effective period is shorter than a prescribed threshold. In addition, the Internet facsimile machine of the present invention includes a designating device for designating the prescribed processing. The prescribed processing is at least one of a processing to save the received simplified image data, and a processing to print the received simplified image data.

Therefore, for example, in the case of the “transient effective period” wherein the effective period of the original image data is shorter than the prescribed threshold, there is a possibility for the original image data being erased after being saved only temporarily at the transmitter. Thus, the received simplified image data is handled as the final image data, and the simplified image data is saved or the image of the simplified image data is printed. Accordingly, the receiver can execute an appropriate processing according to the information of the effective period of the original image data from the transmitter.

### BRIEF DESCRIPTION OF THE DRAWINGS

FIG. 1 is a block diagram showing a configuration of an Internet facsimile machine 20 according to an embodiment of the present invention.

FIG. 2 is a sequence diagram showing a communication procedure between a full-mode Internet facsimile machine 20A and a full-mode Internet facsimile machine 20B of the related art.

FIG. 3 is a flowchart showing a full-mode Internet facsimile transmission processing to be executed by a main control unit 1 of the Internet facsimile machine 20 of FIG. 1.

FIG. 4 is a flowchart showing a transmission error processing (S7, S12, S45) which is a subroutine of FIG. 3, FIG. 6, and FIG. 7.

FIG. 5 is a flowchart showing a transmission completion processing (S11, S46) which is a subroutine of FIG. 3 and FIG. 6.

FIG. 6 is a flowchart showing an image data transmission processing (S9) which is a subroutine of FIG. 3.

FIG. 7 is a flowchart showing a full-mode Internet facsimile reception processing to be executed by the main control unit 1 of the Internet facsimile machine 20 of FIG. 1.

FIG. 8 is a flowchart showing a simplified image data processing (S58) which is a subroutine of FIG. 7.

### DETAILED DESCRIPTION OF THE PREFERRED EMBODIMENT

An embodiment of the present invention will be described with reference to accompanying drawings.

<An Embodiment>

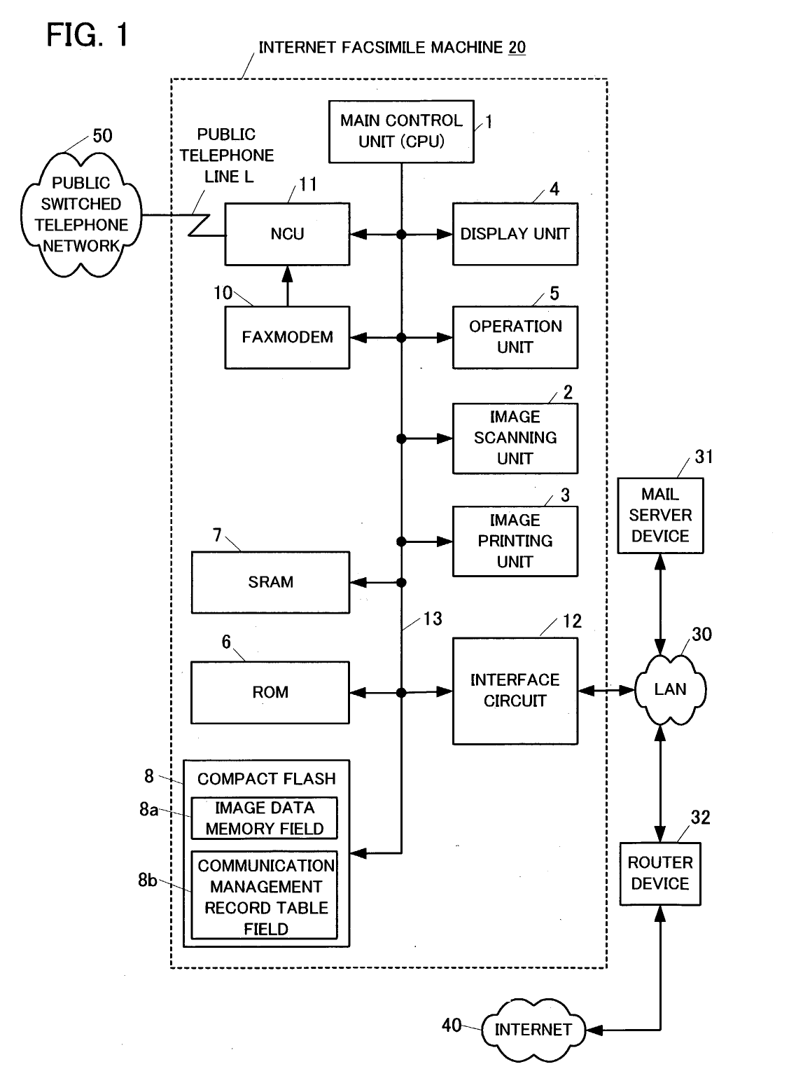

FIG. 1 is a block diagram showing a configuration of an Internet facsimile machine 20 according to an embodiment of the present invention.

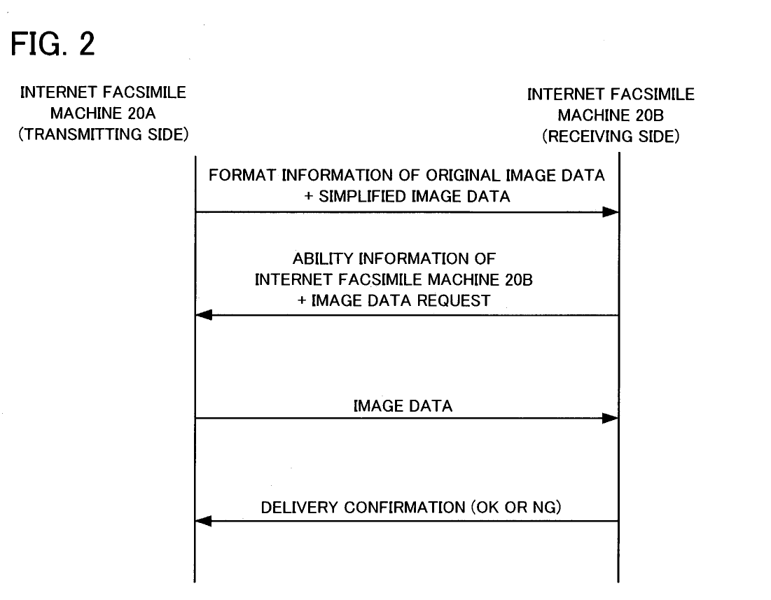

The Internet facsimile machine 20 according to the present embodiment is an Internet facsimile machine for a communication system wherein image data is transmitted and received by using electronic mail in accordance with a communication procedure of FIG. 2. Further, in the communication system, there are a transmitting Internet facsimile machine and a receiving Internet facsimile machine. The transmitting Internet facsimile machine stores an original image data in an image data memory field 8a of a memory device 8 such as a CompactFlash memory device (CompactFlash is a registered trademark of Sandisk Corp. of Santa Clara, Calif.) and transmits a simplified image data including information of the original image data, and information indicating an effective period for holding the original image data (hereinafter referred to as the effective period of the original image data). Moreover, the receiving Internet facsimile machine receives the transmitted simplified image data and the information indicating the effective period. At the transmitting Internet facsimile machine, a user uses an operation unit 5 to declare and designate the effective period of the original image data as

(a) a “transient effective period” having a default time value or a time value changed by the operation unit 5; or

(b) a “permanent effective period” having a limitless time value as long as a memory 8 physically exists and functions.

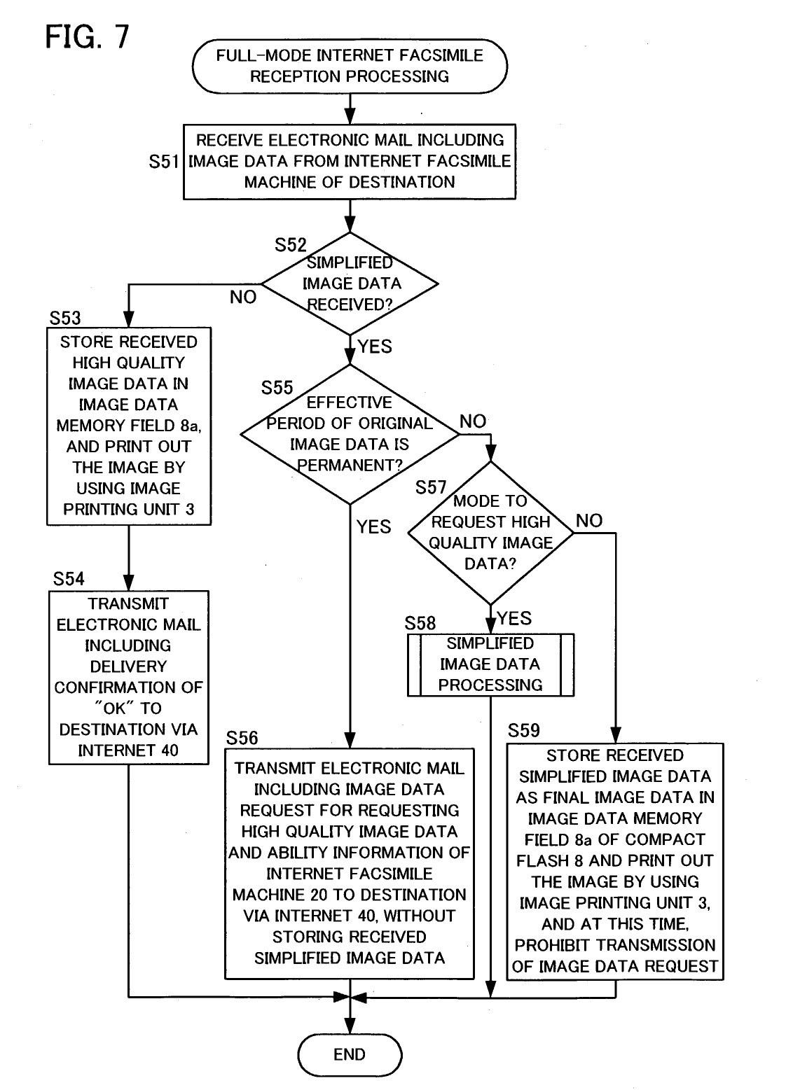

When the effective period of the original image data is the “permanent effective period” (YES in step S55 in FIG. 7), the main control unit 1 of the receiver controls to transmit the image data request for requesting the image data of which the image quality is higher than that of the simplified image data to the transmitter, without saving the received simplified image data in the image data memory field 8a of the memory device 8 (step S56).

Moreover, when the effective period of the original image data is the “transient effective period” (NO in step S55 in FIG. 7), the main control unit 1 of the receiver controls to prohibit the transmission of the image data request for requesting the image data with the image quality higher than that of the simplified image data to the transmitting Internet facsimile machine, by handling the received simplified image data as the final image data (step S59).

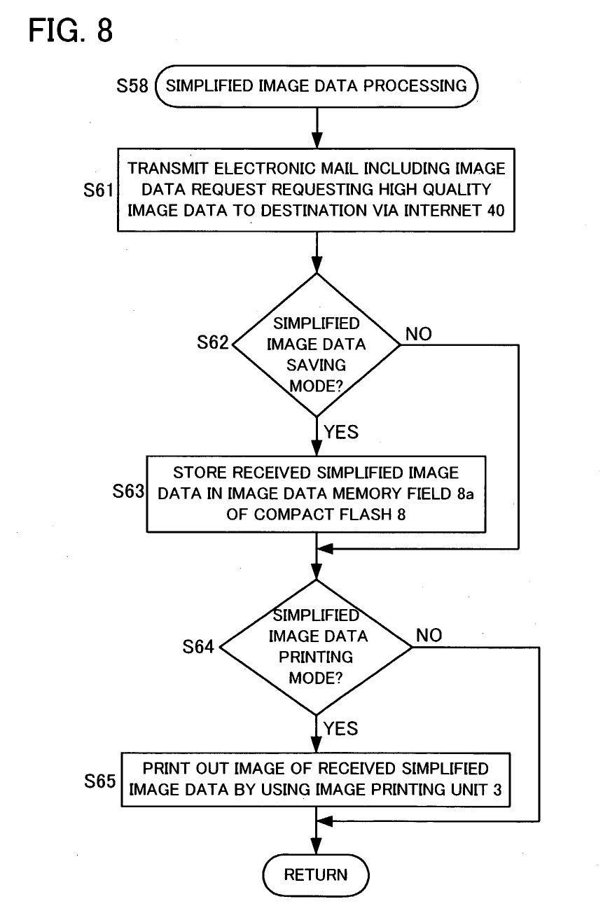

Furthermore, when the effective period of the original image data is the “transient effective period” (NO in step S55 in FIG. 7), the received simplified image data is handled as the final image data. Then, when it is the simplified image data saving mode set by the operation unit 5 (YES in step S62 in FIG. 8), the main control unit 1 of the receiver controls to store the received simplified image data in the image data memory field 8a of the memory device 8 (step S63). Moreover, when it is the simplified image data printing mode set by the operation unit 5 (YES in step S64), the main control unit 1 of receiver controls to print the image of the received simplified image data by using an image printing unit 3 (step S65).

In FIG. 1, the Internet facsimile machine 20 includes a facsimile communication function of a conventional G3 type or the like, and a full-mode Internet facsimile function having the communication procedure of FIG. 2. The main control unit 1 is formed of CPU (Central Processing Unit) specifically. The main control unit 1 is connected to each of the following hardware parts via a bus 13, and controls the hardware parts. In addition, the main control unit 1 executes various functions of software to be described later on. An image scanning unit 2 scans a document by a scanner using CCD (Charged Coupled Device) or the like, and outputs a dotted image data converted into a binary of black and white. The image printing unit 3 is an electro-photographic typed printer or the like, and prints out to record the image data, which is received by the facsimile communication from another facsimile machine, as a hard copy. A display 4 is a displaying device such as a liquid crystal display (LCD) or CRT (Cathode Ray Tube) display. The display 4 displays an operation status of the Internet facsimile machine 20, or displays an image data of a document to be transmitted, and a received image data.

The operation unit 5 includes letter keys, ten-key numeric pad for dialing, speed-dial keys, one-touch dial keys, various function keys or the like that are necessary for operating the Internet facsimile machine 20. Further, by forming the display 4 as a touch panel, a part or all of the various keys in the operation unit 5 can be substituted.

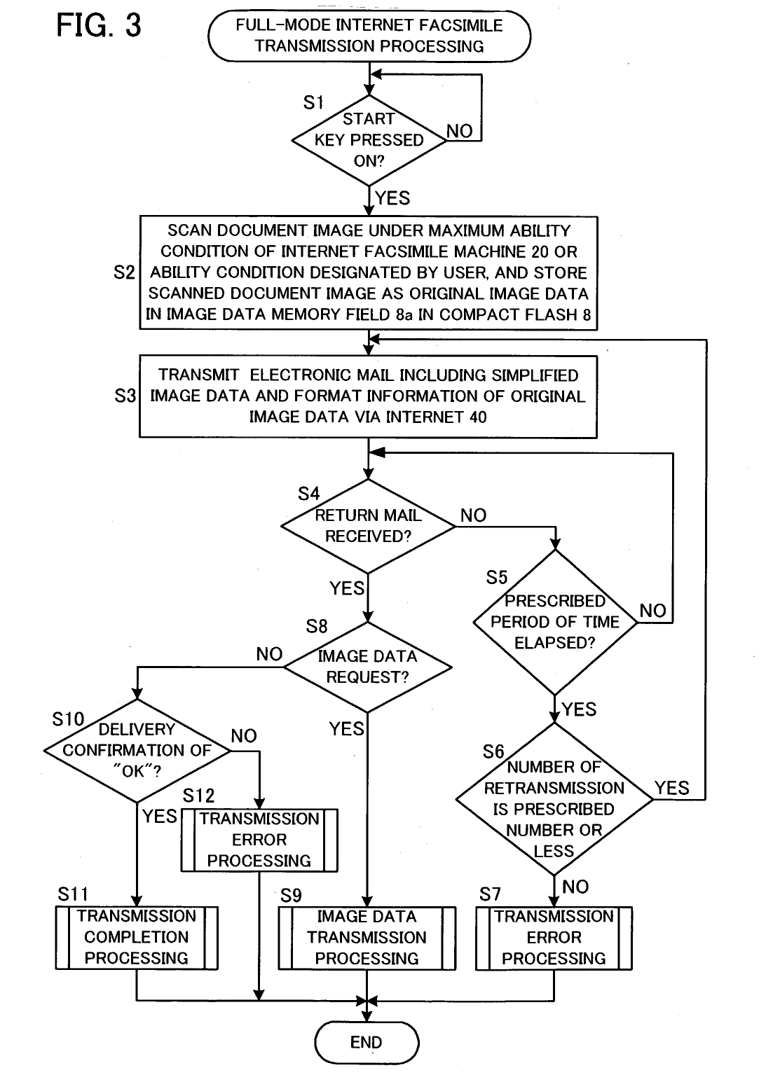

ROM (Read Only Memory) 6 stores in advance, various software programs that are necessary for an operation of the Internet facsimile machine 20 and that are executed by the main control unit 1. The programs include at least a program of a full-mode Internet facsimile transmission processing shown in FIG. 3 through FIG. 6, and a program of a full-mode Internet facsimile reception processing shown in FIG. 7 and FIG. 8. Moreover, the programs can be recorded in a recording medium such as a floppy disk, MO (Magneto-Optic) disk, or DVD-RAM (Digital Versatile Disk-Random Access Memory). The programs can be loaded to SRAM (Static Random Access Memory) 7 via the drive device when necessary, and the programs can be executed. The SRAM 7 is used as a working area of the main control unit 1, and stores temporally data that generates when the program is executed. In addition, the memory device 8 includes the image data memory field 8a that stores the image data, and a communication management record table field 8b that is a memory field for recording a communication management record table.

A faxmodem 10 is a modem connected to a public switched telephone network (PSTN) 50 via a public telephone line L, and includes a faxmodem function for general facsimile communication. NCU (Network Control Unit) 11 is a hardware circuit that carries out closing and releasing operations of a direct current loop or the like of the analogue public telephone line L, and includes an automatic dial function. The NCU 11 connects the faxmodem 10 to the public telephone line L when necessary. Further, the NCU 11 can detect an ID receiving terminal starting signal of a caller ID notification service, and a general telephone calling signal. In addition, the NCU 11 can transmit a first response signal and a second response signal in the caller ID notification service when necessary. Moreover, the NCU 11 can be connected to a digital line (for example, ISDN (Integrated Services Digital Network) line) of a base band transmission method via a prescribed terminal adaptor and DSU (Digital Service Unit).

An interface circuit 12 is LAN (Local Area Network) interface circuit that carries out a signal conversion or a protocol conversion of a signal or data, to connect the Internet facsimile machine 20 to LAN 30 or the like such as an Ethernet. A mail server device 31 and a router device 32 are connected to the LAN 30. Furthermore, the router device 32 is connected to a mail server device of a receiver (not shown in the drawings) via the Internet 40. When transmitting the electronic mail message to another Internet facsimile machine from the Internet facsimile machine 20 after attaching the image data to a main body of an electronic mail message, the electronic mail message is transmitted to the mail server device 31 once via the LAN 30 from the interface circuit 12. Then, the mail server device 31 transmits the Internet mail to the receiving Internet facsimile machine via the LAN 30, the router device 32, the Internet 40, and the receiving mail server device (not shown in the drawings). Meanwhile, when receiving an electronic mail message, the Internet facsimile machine 20 receives the electronic mail message through a path that is the reverse of the above-described path. Further, a line connection to the Internet 40 is not limited to a private line or the like, and can be a dial-up connection using the public telephone line L.

The Internet facsimile machine 20 of the present embodiment having the configuration as described above includes the facsimile communication function of the general G3 method, the Internet, or the like. The Internet facsimile machine 20 also includes an Internet facsimile function. According to the facsimile communication function, the dotted image data scanned by the image scanning unit 2 is encoded by a software in accordance with an encoding method, such as MH (Modified Huffman), MR (Modified Read), or MMR (Modified Modified Read), which are defined in a standard of the facsimile communication. Then, the encoded data is transmitted to the receiving facsimile machine. Meanwhile, the encoded data received from the receiving facsimile machine is decoded into an image data by the software, and output as a hardcopy from the image printing unit 3.

Next, an example of an electronic mail message will be described for the full-mode Internet facsimile transmission of the present embodiment.

First, an example of the electronic mail message for the transmission of the simplified image data is shown in Chart 1. As it is evident from Chart 1, format information of the attached image data (information such as a file format of the image data, a resolution and its horizontal to vertical ratio, an image encoding method, and information of the width of the printing paper size), and format information of the original image data (information such as a file format of the image data, a resolution and its horizontal to vertical ratio, an image encoding method, and information of the width of the printing paper size) are included above the attached TIFF (Tagged Image File Format) image data. Moreover, in the eighth line of Chart 1, it is written “permanent”, and this shows that the original image data holding effective period is “permanent”.

[Chart 1]

An example of the electronic mail message for the transmission of the simplified image data

Date: Wed, 20 Sep 1995 00:18:00+0900

From: Sender@terminalA.ifax

Message-Id: <199509200019.12345@terminalA.ifax>

Subject: Internet FAX Full Mode Sample1

To: Recipient@terminalB.ifax

Disposition-Notification-To: Sender@terminalA.ifax

Disposition-Notification-Options:

Alternative-available=optional,permanent

MIME-Version: 1.0

Content-Type: multipart/mixed;

boundary=“RAA14128.773615765”

--RAA14128.773615765

Content-type: image/tiff,application=faxbw

Content-Transfer-Encoding: base64

Content-features:

(&(color=Binary)

(image-file-structure=TIFF-minimal)

(dpi=200)

(dpi-xyratio=1)

(paper-size=A4)

(image-codng=MH)

(MRC-mode=0)

(ua-media=stationery))

Content-alternative:

(&(color=Binary)

(image-file-structure=TIFF-limited)

(dpi=400)

(dpi-xyratio=1)

(paper-size=A4)

(image-coding=MMR)

(MRC-mode=0) (ua-media=stationery))

[TIFF-FX Profile-S (Image Data)]

--RAA14128.773615765--

Next, an example of an electronic mail message for the transmission of the image data request is shown in Chart 2. As it is evident from Chart 2, ability information of the receiver (information such as a file format of the image data, a processable resolution and its horizontal to vertical ratio, an image encoding method, and information of the width of the printing paper size) is included at the end of the main body of the electronic mail message.

[Chart 2]

An example of the electronic mail message for the transmission of the image data request

Date: Wed, 20 Sep 1995 00:19:00+0900

From: Recipient@terminalB.ifax

Message-Id: <199509200020.12345@terminalB.ifax>

Subject: Re: Internet Fax Full Mode Sample1

To: Sender@terminalA.ifax

MIME-Version: 1.0

Content-Type: multipart/report;

report-type=disposition-notification;

boundary=“RAA14128.773615766”

--RAA14128.773615766

The message sent on 1995 Sep 20 at 00:18:00+0900 to

Receipt@terminaliB.ifax with subject “Internet Fax

Full Mode Sample1” has been received.An alternative

form of the message data is requested.

-RAA14128.773615788

Content-Type: message/disposition-notification

Reporting-UA: Recipient terminalB.ifax;IFAX-FullMode

Original-Recipient: rfc822;Recipient@terminalB.ifax

Final-Recipient: rfc822;Recipient@terminalB.ifax

Original-Message-ID: <199509200019.12345@terminalA.ifax>

Disposition: automatic-action/MDN-sent-automatically;

deleted/alternative-preferred

Media-Accept-Features:

(&(color=Binary)

(image-file-structure=TIFF)

(|(&(dpi=200)(dpi-xyratio=200/100))

(&(dpi=200)(dpi-xyratio=1))

(&(dpi=400)(dpi-xyratio=1)))

(|(image-coding=[MH,MR,MMR])

(&(image-coding=JBIG)

(image-coding-constraint=JBIG-T85)

(JBIG-stripe-size=128)))

(MRC-mode=0)

(paper-size=[A4,B4])

(ua-media=stationery))

--RAA14128.773615766--

Furthermore, an example of an electronic mail message for the second transmission of the image data is shown in Chart 3. As it is evident from Chart 3, the converted TIFF image data is attached to the end of the electronic mail message.

[Chart3]

An example of the electronic mail message for the second transmission of the image data

Date: Wed, 20 Sep 1995 00:21:00+0900

From: Sender@terminalA.ifax

Message-Id: <199509200021.12345@terminalA.ifax>

Original-Message-Id: <199509200019.12345@terminalA.ifax>

Subject: Internet FAX Full Mode Sample2

To: Recipient@terminalB.ifax

Disposition-Notification-To: Sender@terminalA.ifax

MIME-Version: 1.0

Content-Type: multipart/mixed;

boundary=“RAA14128.773615768”

--RAA14128.773615768

Content-type: image/tiff, application=faxbw

Content-Transfer-Encoding: base64

[TIFF-FX Profile-F (Image Data)]

--RAA14128.773615768--

Furthermore, an example of an electronic mail message for the transmission of the delivery confirmation is shown in Chart 4. As it is evident from Chart 4, the delivery confirmation information is inserted at the head of the main body of the electronic mail message, and the ability information of the receiver (information such as a file format of the image data, a processable resolution and its horizontal to vertical ratio, an image encoding method, and the information of the width of the printing paper size) is included at the end of the main body of the electronic mail message.

[Chart 4]

An example of the electronic mail message for the transmission of the delivery confirmation

Date: Wed, 20 Sep 1995 00:22:00+0900

From: Recipient@terminalB.ifax

Message-Id: <199509200022.12345@terminalB.ifax>

Subject: Re; Internet FAX Full Mode Sample2

To:Sender@terminalA.ifax

MIME-Version: 1.0

Content-Type: multipart/report;

report-type=disposition-notification;

boundary=“RAA14128.773615769”

--RAA14128.773615769

The message sent on 1995 Sep 20 at 00:21:00+0900 to

Recipient@terminalB.ifax with subject “Internet FAX

Full Mode Sample2” has been processed in Internet FAX

Full Mode.

--RAA14128.773615769

Content-Type: message/disposition-notification

Reporting-UA: Recipient,terminalB.ifax; IFAX-FullMode

Original-Recipient: rfc822;Recipient@terminalB.ifax

Final-Recipient: rfc822; Recipient@terminalB.ifax

Original-Message-ID: <199509200021.12345@terminalA.ifax>

Disposition: automatic-action/MDN-sent-automatically;processed

Media-Accept-Features:

(&(color=Binary)

(image-file-structure=TIFF)

(|(&(dpi=200)(dpi-xyratio=200/100))

(&(dpi=200)(dpi-xyratio=1))

(&(dpi=400)(dpi-xyratio=1)))

(|(image-coding=[MH,MR,MMR])

(&(image-coding=JBIG)

(image-coding-constraint=JBIG-T85)

(JBIG-stripe-size=128)))

(MRC-mode=0)

(paper-size=[A4,B4])

(ua-media=stationery))

--RAA14128.773615769/terminalB.ifax--

FIG. 3 is a flowchart showing the full-mode Internet facsimile transmission processing to be executed by the main control unit 1 of the Internet facsimile machine 20 of FIG. 1.

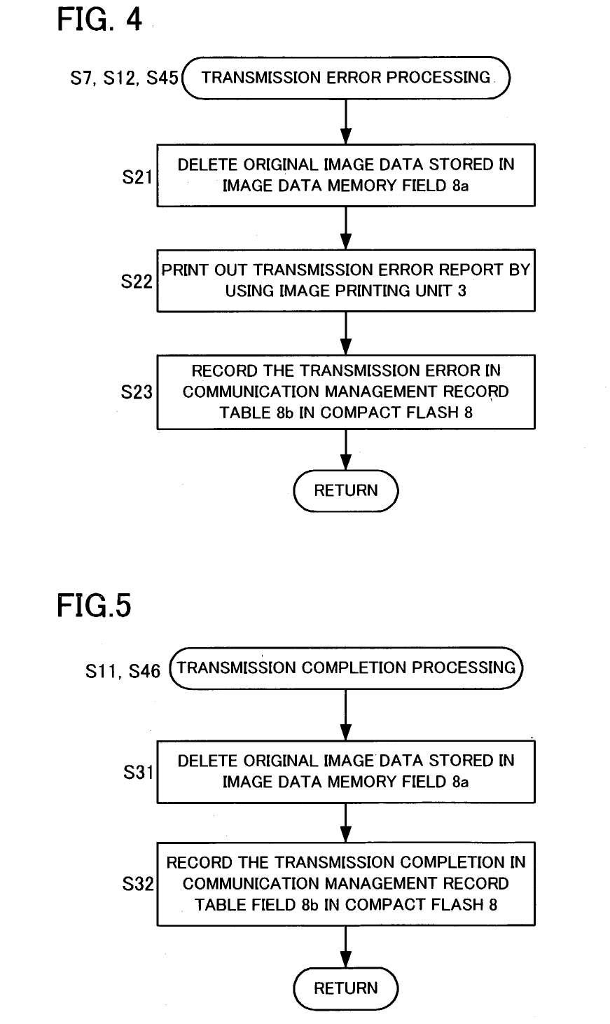

In step S1 of FIG. 3, first, it is determined whether or not a start key is pressed ON. When it is determined YES, in step S2, a document image is scanned under a maximum ability condition of the Internet facsimile machine 20 or under an ability condition designated by the user. In addition, the scanned image is stored in the image data memory field 8a in the memory device 8 as an original image data. In step S3, the electronic mail message including the simplified image data and the format information of the original image data is transmitted to the receiving Internet facsimile machine via the Internet 40. Next, in step S4, it is determined whether or not a return mail message is received from the receiving Internet facsimile machine. When it is determined NO, the process proceeds to step S5. When it is determined YES, the process proceeds to step S8. In step S5, it is determined whether or not a prescribed period of time (for example, 30 minutes) has elapsed. When it is determined NO, the process returns to step S4. When it is determined YES, the process proceeds to step S6. Next, in step S6, it is determined whether or not the number of retransmissions has received a prescribed number (for example, 5 times) or less. When it is determined YES, the process returns to step S3. When it is determined NO, the process proceeds to step S7. In step S7, the transmission error processing of FIG. 4 is executed, and the Internet facsimile transmission processing ends.

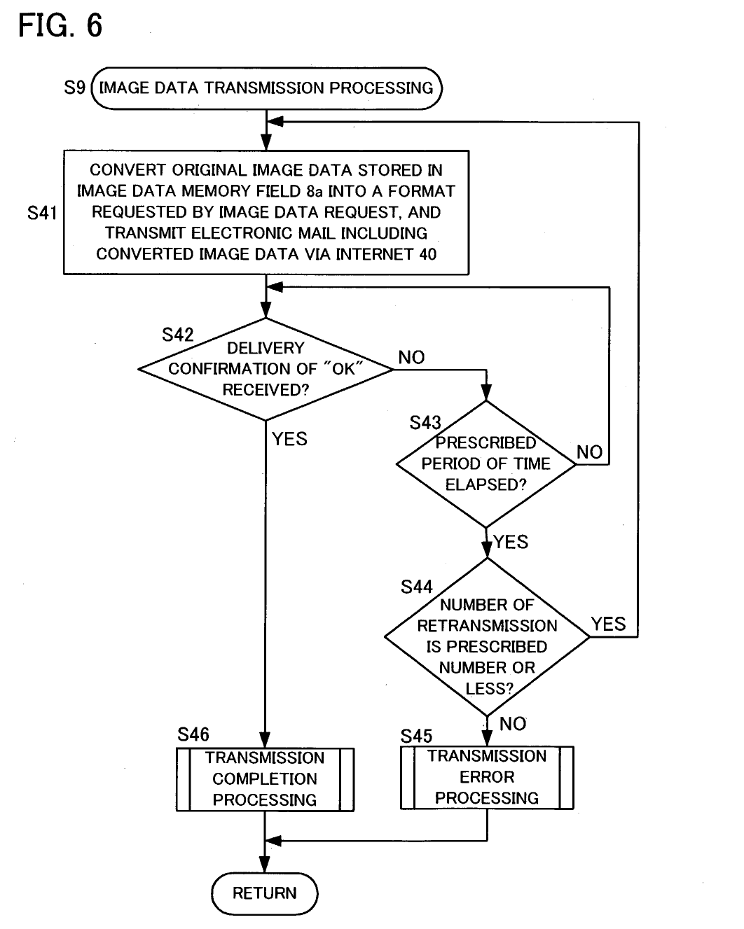

Moreover, in step S8, it is determined whether or not it is the image data requested. When it is determined YES, the process proceeds to step S9. When it is determined NO, the process proceeds to step S10. In step S9, the image data transmission processing of FIG. 6 is executed, and the Internet facsimile transmission processing ends. Meanwhile, in step S10, it is determined whether or not the return mail message is the delivery confirmation of “OK”. When it is determined YES, the process proceeds to step S11. When it is determined NO, the process proceeds to step S12. In step S11, the transmission completion processing of FIG. 5 is executed, and the Internet facsimile transmission processing ends. Meanwhile, in step S12, the transmission error processing of FIG. 4 is executed, and the Internet facsimile transmission processing ends.

FIG. 4 is a flowchart showing the transmission error processing (S7, S12, S45) which is a subroutine of FIG. 3 and FIG. 6.

In step S21 of FIG. 4, the original image data stored in the image data memory field 8a is deleted. In step S22, when the return mail message cannot be received from the destination, or when receiving the delivery confirmation of “NG”, the transmission error report notifying that the original image data has been deleted is printed out by using the image printing unit 3. In step S23, the transmission error is recorded in the communication management record table field 8b of the memory device 8, and the process returns to the original main routine.

FIG. 5 is a flowchart showing the transmission completion processing (S11, S46) which is a subroutine of FIG. 3 and FIG. 6.

In step S31 of FIG. 5, the original image data stored in the image data memory field 8a is deleted. In step S32, the transmission completion is recorded in the communication management record table field 8b of the memory device 8, and the process returns to the original main routine.

FIG. 6 is a flowchart showing the image data transmission processing (S9) which is a subroutine of FIG. 3.

In step S41 of FIG. 6, first, the original image data in the image data memory field 8a is converted into a format requested by the image data request. In addition, the electronic mail message including the converted image data is transmitted to the receiving Internet facsimile machine of the via the Internet 40. In step S42, it is determined whether or not the delivery confirmation of “OK” is received. When it is determined NO, the process proceeds to step S43. When it is determined YES, the process proceeds to step S46. In step S43, it is determined whether or not a prescribed period of time (for example, 30 minutes) has elapsed. When it is determined NO, the process returns to step S42. When it is determined YES, the process proceeds to step S44. In step S44, it is determined whether or not the number of retransmissions has reached a prescribed number (for example, 5 times) or less. When it is determined YES, the process returns to step S41. When it is determined NO, the process proceeds to step S45. In step S45, the transmission error processing of FIG. 4 is executed, and the process returns to the original main routine. Meanwhile, in step S46, the transmission completion processing of FIG. 5 is executed, and the process returns to the original main routine.

FIG. 7 is a flowchart showing the full-mode Internet facsimile reception processing to be executed by the main control unit 1 of the Internet facsimile machine 20 of FIG. 1.

In step S51 of FIG. 7, the electronic mail message including the image data is received from the receiving Internet facsimile machine. In step S52, it is determined whether or not the simplified image data is received. When it is determined YES, the process proceeds to step S55. When it is determined NO, the process proceeds to step S53. In step S53, the received high quality image data is stored in the image data memory field 8a, and the image of the received high quality image data is printed out by using the image printing unit 3. In the step S54, the electronic mail message including the delivery confirmation of “OK” is transmitted to the destination via the Internet 40, and the Internet facsimile reception processing ends. Further, although not shown in the processing of FIG. 7, in case of trouble such as an interruption occurring in the process of step S53, the delivery confirmation of “NG” is transmitted to the destination.

Meanwhile, when it is determined YES in step S52, it is determined whether or not the effective period of the original image data included in the received information is “permanent effective period” in step S55. When it is determined YES, the process proceeds to step S56. When it is determined NO, the process proceeds to step S57. In step S56, without storing the received simplified image data in the image data memory field 8a of the memory device 8, the electronic mail message including the image data request for requesting the high quality image data and the ability information of Internet facsimile machine 20 is transmitted to the destination via the Internet 40. Then, the Internet facsimile reception processing ends.

Moreover, in step S57, it is determined whether or not it is a mode for requesting the high quality image data which is set by using the operation unit 5. When the mode for requesting the high quality image data is set, the process proceeds to step S58. In step S58, the simplified image data processing is executed, and the Internet facsimile reception processing ends. Meanwhile, when the mode for requesting the high quality image data is not set in step S57, in step S59, the received simplified image data is stored in the image data memory field 8a of the memory device 8 as the final image data. Then, the image of the received simplified image data is printed out by using the image printing unit 3, and at this time, the transmission of the image data request is prohibited. After the process of the step S59, the Internet facsimile reception processing ends.

FIG. 8 is a flowchart showing the simplified image data processing (S58) which is a subroutine of FIG. 7.

In step S61 of FIG. 8, the electronic mail message including the image data request for requesting the high quality image data is transmitted to the destination via the Internet 40. In step S62, it is determined whether or not the simplified image data saving mode to be set by using the operation unit 5 is set. When it is determined NO, the process proceeds to step S64. When it is determined YES, the process proceeds to step S63. In step S63, the received simplified image data is stored in the image data memory field 8a of the memory device 8. Then, the process proceeds to step S64. In step S64, it is determined whether or not it is the simplified image data printing mode to be set by using the operation unit 5. When it is determined NO, the process returns to the original main routine. When it is determined YES, the process proceeds to step S65. In step S65, the image of the received simplified image data is printed out by using the image printing unit 3, and the process returns to the original main routine.

In step S63 of the simplified image data processing of FIG. 8, in the case the simplified image data is stored in the image data memory field 8a of the memory device 8, the user can print out an image randomly. For example, when the original image data or the image data with the image quality higher than that of the simplified image data does not arrive from the destination within a prescribed period of time, the user can print out the image. Alternatively, when receiving an electronic mail message of a notification notifying the deletion of the original image data from the destination, the user can print out the image.

The full-mode Internet facsimile machine 20 transmits the simplified image data accompanying the information of the original image data at first. Then, when there is the image data request from the destination, the full-mode Internet facsimile machine 20 transmits the high quality image data corresponding to the ability of the destination. However, it is necessary for the transmitting Internet facsimile machine 20 to hold the original image data during this period of time. Therefore, when transmitting the simplified image data at first, the effective period of the original image data can be designated as transient or permanent. In the case it is declared as permanent, when the original image data is requested, the original image data can be expected to be returned without any problem. However, in the case it is declared as transient, there are cases when the original image data is erased before the image data request for requesting the original image data or the image data with the image quality higher than that of the simplified image data arrives at the destination. Therefore, in the receiving Internet facsimile machine 20, the following processing is executed.

(1) In the case it is declared as permanent, the received simplified image data is deleted instantly, and the image data request for requesting the original image data or the image data with the image quality higher than that of the simplified image data is transmitted to the destination.

(2) In the case it is declared as transient, the image data request for requesting the original image data or the image data with the image quality higher than that of the simplified image data is not transmitted, and the simplified image data is processed as the received document, specifically, the simplified image data is stored in the image data memory field 8a and printed out.

(3) In the case it is declared as transient, a determination for whether or not to transmit the image data request for requesting the original image data or the image data with the image quality higher than that of the simplified image data can be set selectively, and specifically, a mode for requesting the high quality image data can be set on or off by using the operation unit 5.

(4) In the case it is declared as transient, and when transmitting the image data request for requesting the original image data or the image data with the image quality higher than that of the simplified image data, a simplified image data saving mode for saving the first simplified image data without deleting, and a simplified image data printing mode for printing out the image of the simplified image data can be selected selectively.

As described above, according to the present embodiment, when the effective period of the original image data is the “permanent effective period” (YES in the step S55 in FIG. 7), the main control unit 1 of the receiver controls to transmit the image data request for requesting the image data with the image quality higher than that of the simplified image data to the transmitter, without saving the received simplified image data in the image data memory field 8a of the memory device 8 (step S56). Therefore, in the case the effective period of the original image data is the “permanent effective period”, the simplified image data of which the original image data is saved reliably at the transmitter is not saved. In other words, the memory resource can be used effectively without the unnecessary image data being saved. Accordingly, the receiver can execute an appropriate processing according to the information of the effective period of the original image data from the transmitter.

Moreover, when the effective period of the original image data is the “transient effective period” (NO in step S55 in FIG. 7), the main control unit 1 of the receiver controls to prohibit the transmission of the image data request for requesting the image data with the image quality higher than that of the simplified image data to the transmitting Internet facsimile machine by handling the received simplified image data as the final image data (step S59). Therefore, when the effective period of the original image data is the “transient effective period”, there is a possibility for the original image data being erased after saved only temporarily at the transmitter. Thus, the received simplified image data is handled as the final image data, and the image data request is not transmitted. Accordingly, the communication error due to the transmission of the image data request after the original image data being erased can be prevented from occurring. As a result, the receiver can execute an appropriate processing according to the information of the effective period of the original image data from the transmitter.

Furthermore, when the effective period of the original image data is the “transient effective period” (NO in step S55 in FIG. 7), the received simplified image data is handled as the final image data. In addition, when it is the simplified image data saving mode set by the operation unit 5 (YES in step S62 in FIG. 8), the main control unit 1 of the receiver controls to store the received simplified image data in the image data memory field 8a of the memory device 8 (step S63). When it is the simplified image data printing mode set by the operation unit 5 (YES in step S64), the image of the received simplified image data is printed out by using the image printing unit 3 (step S65). Therefore, when the effective period of the original image data is the “transient effective period”, there is a possibility for the original image data being deleted after saved only temporarily at the transmitter. Thus, the received simplified image data is handled as the final image data, and the simplified image data is saved or the image of the simplified image data is printed out. Accordingly, the receiver can execute an appropriate processing according to the information of the effective period of the original image data from the transmitter.

<Variation>

In the above-described embodiment, an example of the Internet facsimile machine 20 was described. However, the present invention is not limited to this example, and for example, the present invention can be applied to communication terminal devices including a telephone set, a data communication device or the like that are connected to a public network, such as a public switched telephone network or a public digital line network.

In the above-described embodiment, the effective period of the original image data is declared and set as the “transient effective period” or the “permanent effective period”. However, the present invention is not limited to this example, and for example, a default time value or a time value of the effective period input by using the operation unit 5 can be set for the effective period of the original image data. In this case, the time value of the “transient effective period” of the former is set shorter than the time value of the “permanent effective period” of the latter. The time value of the “transient effective period” of the former deals with a case in which the effective period of the original image data is longer than a prescribed threshold. Meanwhile, the time value of the “permanent effective period” of the latter deals with a case in which the effective period of the original image data is longer than a prescribed threshold. Further, the time value can be not set for the “permanent effective period” of the latter.

What is claimed is:

1. An Internet facsimile machine, comprising:
means for receiving simplified image data and information of an effective period for saving original image data by an electronic mail message;
a storage unit for storing the received simplified image data; and
means for controlling to transmit an image data request for requesting high quality image data with an image quality higher than that of received simplified image data without saving the received simplified image data in the storage unit when the received effective period is longer than a prescribed threshold.

2. The Internet facsimile machine according to claim 1, wherein information indicating a transient effective period or a permanent effective period is received as information indicating the effective period, and the means for controlling determines that the received effective period is longer than the prescribed threshold when receiving the information indicating the permanent effective period.

3. An Internet facsimile machine, comprising:
means for receiving simplified image data and information of an effective period for saving original image data by an electronic mail message; and
means for controlling to prohibit a transmission of an image data request for requesting image data of which an image quality is higher than that of the simplified image data by handling the received simplified image data as a final image data when the received effective period is shorter than a prescribed threshold.

4. The Internet facsimile machine according to claim 3, wherein information indicating a transient effective period or a permanent effective period is received as information indicating the effective period, and the means for controlling determines that the received effective period is shorter than the prescribed threshold when receiving the information indicating the transient effective period.

5. The Internet facsimile machine according to claim 3, further comprising a storage unit for storing the received simplified image data, wherein the means for controlling can selectively set a mode for whether or not to transmit the image data request, and controls to transmit the image data request to the transmitting Internet facsimile machine when the received effective period is shorter than the prescribed threshold and a mode for transmitting the image data request is set.

6. The Internet facsimile machine according to claim 3, further comprising a storage unit for storing the received simplified image data, wherein the means for controlling can selectively set a mode for whether or not to transmit the image data request, and controls to prohibit a transmission of the image data request and to save the received simplified image data as a final image data in the storage unit when the received effective period is shorter than the prescribed threshold and mode to a transmit the image data request is not set.

7. The Internet facsimile machine according to claim 3, further comprising a storage unit for storing the received simplified image data, wherein the means for controlling can selectively set a mode for whether or not to transmit the image data request, and controls to prohibit a transmission of the image data request and to print out the received simplified image data when the received effective period is shorter than the prescribed threshold and a mode to transmit the image data request is not set.

8. An Internet facsimile machine, comprising:
means for receiving simplified image data and information of an effective period for saving original image data;
means for transmitting an image data request including ability information by an electronic mail message;
a storage unit for storing the received simplified image data; and
means for deciding whether or not to save the received simplified image data in the storage unit in accordance with received information of the effective period.

9. The Internet facsimile machine according to claim 8, wherein the means for deciding controls to prohibit to save the received simplified image data in the storage unit when the received effective period is longer than a prescribed threshold.

10. The Internet facsimile machine according to claim 8, wherein when the received effective period is longer than a prescribed threshold, the means for deciding controls to prohibit to save the received simplified image data in the storage unit, and controls to transmit the image data request to a transmitting Internet facsimile machine using electronic mail.

11. The Internet facsimile machine according to claim 9, wherein information indicating a transient effective period or a permanent effective period is received as information indicating the effective period, and the means for deciding determines that the received effective period is longer than the prescribed threshold when receiving the information indicating the permanent effective period.

12. An Internet facsimile machine, comprising:
means for receiving simplified image data and information of an effective period for saving original image data;
means for transmitting an image data request including ability information; and
means for deciding whether or not to transmit the image data request by using an electronic mail message in accordance with received information of the effective period.

13. The Internet facsimile machine according to claim 12, wherein when the received effective period is longer than a prescribed threshold, the means for deciding controls to transmit the image data request by using electronic mail to the transmitting Internet facsimile machine and when the received effective period is shorter than a prescribed threshold, the means for deciding controls to prohibit the transmission of the image data request using electronic mail to the transmitting Internet facsimile machine.

14. The Internet facsimile machine according to claim 13, wherein information indicating a transient effective period or a permanent effective period is received as information indicating the effective period, and when receiving the information indicating the transient effective period, the means for deciding determines that the received effective period is shorter than the prescribed threshold, and when receiving the information indicating the permanent effective period, the means for deciding determines that the received effective period is longer than a prescribed threshold.

15. An Internet facsimile machine, comprising:
means for receiving simplified image data and information of an effective period for saving original image data;
means for controlling to execute a prescribed processing to the received simplified image data when the received effective period is shorter than a prescribed threshold; and
means for designating the prescribed processing.

16. The Internet facsimile machine according to claim 15, wherein the prescribed processing is a processing to save the received simplified image data.

17. The Internet facsimile machine according to claim 15, wherein the prescribed processing is a processing to print the received simplified image data.

18. An Internet facsimile machine, comprising:
means for receiving simplified image data and information of an effective period for saving original image data;
means for transmitting an image data request including ability information by an electronic mail message;
means for storing the received simplified image data; and
means for controlling to execute a processing to save the received simplified image data in the means for storing when the received effective period is shorter than a prescribed threshold.

19. The Internet facsimile machine according to claim 18, wherein the means for controlling can selectively set a mode for whether or not to save the simplified image data, and controls to execute a processing to save the received simplified image data in the means for storing when the received effective period is short than the prescribed threshold and a simplified image data saving mode for saving the simplified image data is set.

20. An Internet facsimile machine, comprising:
means for receiving simplified image data and information of an effective period for saving original image data;
means for transmitting an image data request including ability information by an electronic mail message;
means for printing the received simplified image data; and
means for controlling to execute a processing to print the received simplified image data by using the means for printing when the received effective period is shorter than a prescribed threshold.

21. The Internet facsimile machine according to claim 20, wherein the means for controlling can selectively set a mode for whether or not to print out the simplified image data, and controls to execute a processing to print out the received simplified image data by using the means for printing when the received effective period is shorter than the prescribed threshold and a simplified image data printing mode for printing the simplified image data is set.

22. The Internet facsimile machine according to claim 15, wherein information indicating a transient effective period or a permanent effective period is received as information indicating the effective period, and the means for controlling determines that the received effective period is shorter than the prescribed threshold when receiving the information indicating the transient effective period.

23. An Internet facsimile machine, comprising:
a receiver receiving simplified image data and information of an effective period for saving original image data by an electronic mail message;
a storage unit storing the received simplified image data; and
a control unit controlling to transmit an image data request for requesting high quality image data with an image quality higher than that of the received simplified image data without saving the received simplified image data in the storage unit when the received effective period is longer than a prescribed threshold.
